(19) United States
(12) Patent Application Publication
(10) Pub. No.: US 2026/0081878 A1
(43) Pub. Date: Mar. 19, 2026

(54) MODULAR COMMUNICATION SYSTEMS

(71) Applicant: CenturyLink Intellectual Property LLC, Denver, CO (US)

(72) Inventor: Tim Hong, Parker, CO (US)

(73) Assignee: CenturyLink Intellectual Property LLC, Denver, CO (US)

(21) Appl. No.: 19/332,635

(22) Filed: Sep. 18, 2025

Related U.S. Application Data
(60) Provisional application No. 63/695,980, filed on Sep. 18, 2024.

(51) Int. Cl. H04L 49/351; H04Q 11/00

(52) U.S. Cl. CPC H04L 49/351; H04Q 11/0067

(57) ABSTRACT

Systems described herein include a switch extension that provides additional switching functionality to an existing networking device without the need to remove or replace the networking device. The switch extension includes a multi-port switch that can be attached to an existing networking device having one or more network interface connectors. In addition, modular communication components, such as a modular modem component and a modular WiFi component, may each have a similar or identical housing, along with power input and power output connectors that permit them to be stacked and interconnected to form an easily upgradable modular networking device.

### CROSS-REFERENCE TO RELATED TO APPLICATIONS

This application claims the benefit of U.S. Provisional Application No. 63/695,980 filed Sep. 18, 2024, entitled “Modular Communication System,” which is incorporated herein by reference in its entirety.

### BACKGROUND

Some networking devices, such as gateway routers, include integrated communication modules that include, for example, modem circuitry, fiber-optic network circuitry, WiFi circuitry, multi-port switches, and/or other networking-related circuitry. It is often difficult to add or replace portions of the system that fail or become outdated. For example, it may be difficult to upgrade from WiFi 6 to WiFi 7 without replacing the whole system. It is with respect to this general technical environment that aspects of the present disclosure are directed.

### SUMMARY

The present application describes a communication system including: a switch extension configured to be detachably connected to a networking device, the switch extension including: a housing configured to be detachably connected to an exterior of the networking device, the housing having a first end that flushly abuts the networking device when connected to the networking device and a second end that is opposite the first end; a first network interface extension connector, attached to the housing proximal the first end of the housing and configured to be connected to a first network interface device connector of the networking device; a plurality of second network interface extension connectors attached proximal the second end of the housing, electrically connected to the first network interface extension connector through switching circuitry of the switch extension; an extension power output connector configured to connect to, and provide power to, a device power input connector of the networking device; and an extension power input connector attached proximal to the second end of the housing and electrically connected to both the power output connector and the switching circuitry, where the extension power input connector is configured to provide power both to the networking device through the power output connector and to the switching circuitry.

In some examples, and in combination with any of the above aspects and examples, the communication system further includes: a cable passthrough including a first opening on the first end of the housing, a second opening on a second end of the housing, and a passageway therebetween.

In some examples, and in combination with any of the above aspects and examples, the switch extension further includes: a fiber cable that passes through the cable passthrough, where a first end of the fiber cable extends beyond the second end of the housing and is configured to be connected with fiber interface device connector of the networking device.

In some examples, and in combination with any of the above aspects and examples, the fiber cable is a passive optical network (PON) cable.

In some examples, and in combination with any of the above aspects and examples, the first network interface extension connector is an 8-pin standardized interface connector.

In some examples, and in combination with any of the above aspects and examples, the 8-pin standardized interface connector is a clipless male-gendered RJ45 connector that supports a bandwidth of up to 10 gigabits/second (Gbps).

In some examples, and in combination with any of the above aspects and examples, the plurality of second network interface extension connectors includes a plurality of 8-pin connectors each supporting a bandwidth of up to 1 Gbps, 2.5 Gbps, or 5 Gbps.

In some examples, and in combination with any of the above aspects and examples, the plurality of 8-pin connectors and the switching circuitry implement a four-port switch.

In some examples, and in combination with any of the above aspects and examples, the communication system further includes the networking device.

The present application further describes a modular communication system including: a modem modular component including: a first housing having a first form factor, the first housing including a first power input connector and a first power output connector, and modem circuitry enclosed by the first housing and coupled with the first power input connector; and a WiFi modular component including: a second housing having the first form factor, the second housing including a second power input connector and a second power output connector, and WiFi circuitry enclosed by the second housing and coupled with the second power input connector, where the WiFi module is configured to be coupled with the modem module by connecting the first power output connector with the second power input connector.

In some examples, and in combination with any of the above aspects and examples, the modular communication system includes a router modular component including: a third housing having the first form factor, the third housing including a third power input connector and a third power output connector, and router circuitry enclosed by the third housing and coupled with the third power input connector, where the router module is configured to be coupled, via the third power input connector, with one of: the first power output connector of the modem module or the second power output connector of the WiFi module.

In some examples, and in combination with any of the above aspects and examples, the modular communication system further includes: a storage modular component including: a fourth housing having the first form factor, the fourth housing including a fourth power input connector and a fourth power output connector, and storage circuitry enclosed by the fourth housing and coupled with the fourth power input connector, where the storage module is configured to be coupled, via the fourth power input connector, with one of: the first power output connector of the modem module or the second power output connector of the WiFi module.

In some examples, and in combination with any of the above aspects and examples, the first form factor includes a first side that includes an indented portion and a second side opposite the first side that includes one or more protrusions.

In some examples, and in combination with any of the above aspects and examples, the first power input connector of the modem module is configured to receive first power and first data and the first power output connector is configured to supply second power and second data to the second power input connector of the WiFi module.

In some examples, and in combination with any of the above aspects and examples, the WiFi circuitry supports a WiFi standard.

In some examples, and in combination with any of the above aspects and examples, the modem circuitry supports a digital subscriber line (DSL) standard, a PON standard, or both.

The present application further describes a method performed at a networking system including a switch extension detachably connected to a networking device, the method including: receiving a first signal at a first network interface extension connector of a multi-port switch included in the switch extension; outputting the first signal via a second network interface extension connector of the switch extension; receiving the first signal at a first network interface device connector; and processing the first signal using modem circuitry of the networking device to generate a second signal; and outputting the second signal.

In some examples, and in combination with any of the above aspects and examples, the method further includes routing the second signal to an endpoint device using a router of the networking device.

In some examples, and in combination with any of the above aspects and examples, the method further includes receiving a third signal via a fiber device connector of the networking device; processing the third signal using circuitry of the networking device to generate a fourth signal; outputting the fourth signal via the first network interface device connector; receiving the fourth signal at the second network interface extension connector; and outputting the fourth signal via a third network interface extension connector of the multi-port switch.

In some examples, and in combination with any of the above aspects and examples, the first signal is received at 10 Gbps and the fourth signal is outputted at 1 Gbps.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A depicts an example networking device according to aspects of the present application.

FIG. 1B depicts a block diagram of a back view of the networking device of FIG. 1A.

FIG. 1C depicts a block diagram of an example switch extension and certain related components thereof according to aspects of the present application.

FIG. 1D depicts an example networking system according to aspects of the present application.

FIG. 2A is a block diagram depicting an example system according to aspects of the present application.

FIG. 2B depicts an example of stacked modular networking components according to aspects of the present application.

FIGS. 2C-2D depict front perspective and back perspective views of an example modular networking component according to aspects of the present application.

FIG. 3 depicts an example method for using a networking system according to aspects of the present application.

FIG. 4 is a block diagram of an example computing system that can be employed in relation to the present application.

### DETAILED DESCRIPTION

Some networking devices, such as gateway routers, include integrated communication modules that include, for example, modem circuitry, fiber-optic network circuitry, WiFi circuitry, router circuitry, multi-port switches, and/or other networking-related circuitry. Such networking devices may be installed at a residence or small business, for example, to enable network connectivity between a local network (e.g., a local area network (LAN)) and a larger network (e.g., a wide area network (WAN) such as the Internet). In some cases, such networking devices are installed by attaching them to an exterior wall of the residence or small business.

Because the modules in the networking device are typically contained within a single housing it may be difficult to add or replace a module if the module fails or becomes outdated.

For examples, some networking devices may become outdated because they have too few ports to accommodate a particular intended use. Thus, such networking devices are often replaced as a whole, even in cases when only a single module requires replacement or updating. Such an approach may be inefficient and costly, and moreover, may result in unused serviceable components (e.g., components from units that have been replaced).

As described herein, a switch extension provides additional switching functionality to an existing networking device without the need to remove or replace the networking device. The switch extension includes a multi-port switch that can be attached to an existing networking device having one or more network interface connectors, for example.

As further described herein, modular communication components, such as a modular modem component and a modular WiFi component, can be used to easily add or upgrade particular network modules without the need to replace an entire networking device. Such modular components may each include power input connectors and power output connectors and be contained in similar housings to permit them to be stacked and interconnected to form an easily upgradable modular networking device.

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the figures can comprise one or more machines or devices that are operatively connected to cooperate in order to provide the described system functionality. The following detailed description is therefore not to be taken in a limiting sense.

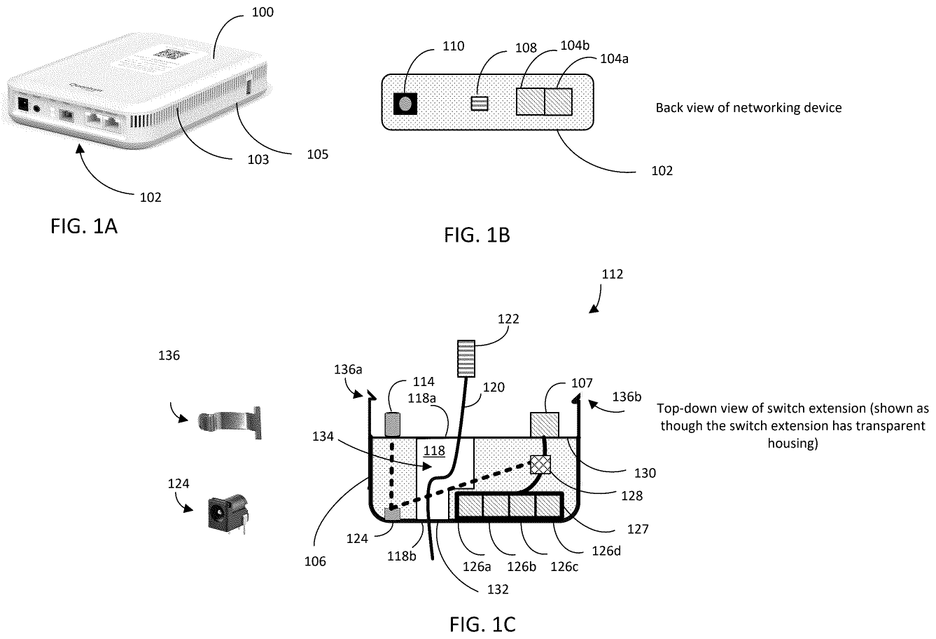

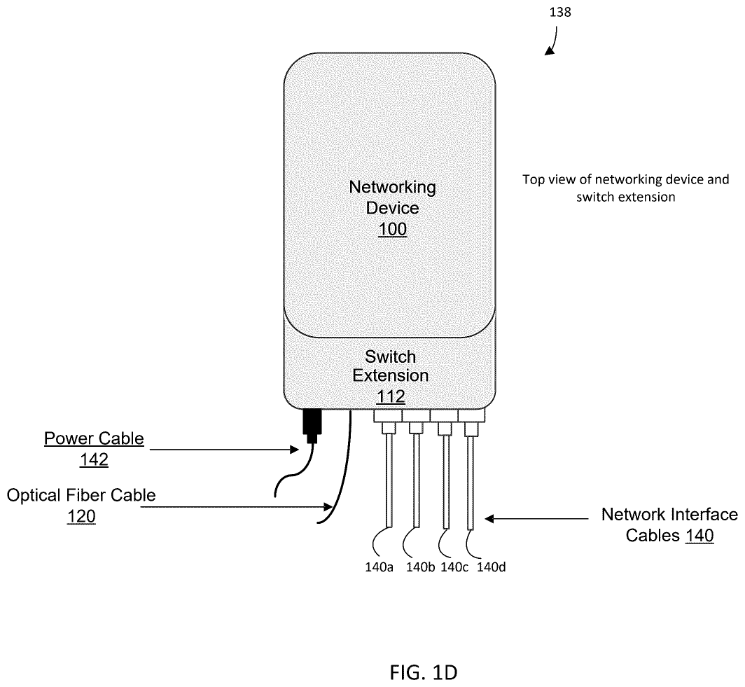

FIG. 1A depicts a nonexclusive example of a networking device 100 that enables network communications. The networking device 100 is intended to be installed at a residence or business to enable a local network of the residence or business to connect to a larger external wide area network (WAN), such as the Internet.

In this example, the networking device 100 includes a modem (e.g., circuitry that enables a local network to connect to, for example, the Internet, by modulating digital signals into analog signals and vice versa) and fiber network circuitry within the housing (not shown) to enable the networking device 100 to communicate with an external network via a fiber optical cable. The networking device 100 includes processing circuitry to process signals transceived by the networking device 100 via various cables connected to connectors of the networking device 100 (such as described in more detail below). In the depicted example of FIG. 1A, the housing 105 of the networking device 100 includes multiple ribs 103 separated by openings in the housing of the networking device 100, which may be useful in dissipating heat.

FIG. 1B depicts a back view 102 of the networking device 100 (e.g., a view of a back side of the networking device 100), showing the various input/output (I/O) connectors (e.g., ports, sockets) of the networking device 100. In this nonexclusive example, the back view 102 depicts a first network interface device connector 104a and a second network interface device connector 104b (collectively, connectors 104) that are each configured to be connected with a wired network cable (such as an Ethernet cable terminating in an 8-pin connector). The first network interface device connector 104a and a second network interface device connector 104b may be female-gendered connectors (e.g., sockets) and included in a two-port switch (or larger multi-port switch) of the networking device 100, such as to enable switching between signals received via multiple connectors 104. In other examples, a networking device may include a single network interface connector 104, such as by excluding the first network interface device connector 104a or the second network interface device connector 104b.

The network interface device connectors 104 may be RJ45 connectors (commonly used for connecting Ethernet cables) or another type of network connector. In some examples, the first network interface device connector 104a is a different type of connector than the second network interface device connector 104b.

In the example of FIGS. 1A-B, the networking device 100 also includes a fiber device connector 108 (e.g., a fiber socket) for connecting a fiber optic cable to networking device 100 (e.g., to connect networking device 100 to a WAN, such as the Internet, via a fiber optic cable that is connected upstream to one or more fiber optic networking devices), and a power input connector 110 for receiving power for the networking device 100.

The networking device 100 may be configured to transceive signals having a bandwidth of up to 1 Gbps, 5 Gbps, 10 Gbps, or another bandwidth, such as by receiving and/or transmitting signals from wired or fiber optic cables via a network interface device connector 104 and/or via the fiber device connector 108, respectively. In some examples, the first network interface connector 104a and/or the second network interface connector 104b may be or may include an 8-pin 10 Gbps connector (such as an RJ45 connector), a 5 Gbps connector, or a 1 Gbps connector. In some examples, the fiber device connector 108 is configured to connect to a subscriber connector angled physical contact (SC/APC) connector of a fiber cable to provide a passive optical networking (PON) connection to a WAN. In some examples, the fiber device connector 108 supports up to a 10 Gbps bandwidth or more.

FIG. 1C depicts a schematic representation of an example switch extension 112 according to aspects of the present disclosure. Switch extension 112 includes connectors that are configured to be plugged into the back side of the networking device 100 (e.g., shown in FIG. 1B) to extend the functionality of the networking device 100 when the switch extension 112 is detachably connected to the networking device 100.

A housing 106 of the switch extension 112 is attached to (or includes) one or more tension clips 136. The tension clips 136 may be attached to, or form, extending side portions of the switch extension 136 that are configured to physically hold a first end 130 of the switch extension 112 against (e.g., proximal to, abutting) the back side of the networking device 100 when the switch extension 112 is connected to the networking device 100. For example, a portion of the tension clip 136 on each side of the switch extension 112 may be inserted between a particular pair of the ribs 103 of the networking device 100 (or into another opening in the housing 105 of the networking device 100). The tension clips 136 may be made of a flexible material with sufficient rigidity to create inward pressure (towards the networking device 100), when the switch extension 112 is installed. When the switch extension is to be removed, the distal ends of extension clips 136 may be bent away from the networking device 100 (e.g., to disengage the tension clips 136 from the openings between the ribs 103). Thus, the housing 106 of the extension switch 112 is configured to be detachably connected to the networking device 100 using the tension clips 136.

The housing 106 may be attached to (e.g., includes and/or is connected to) multiple electrical connectors, some of which may protrude from the housing 106 (e.g., to enable connection to corresponding connectors on the networking device 100). For example, the switch extension 112 includes a first network interface extension connector 107 that protrudes from the housing 106 and is configured to be plugged into the first network interface device connector 104a. In some examples, the first network interface extension connector 107 is physically located at a position on the housing 106 such that it is vertically and horizontally aligned to the first network interface device connector 104a when the extension switch 112 is attached to the networking device 100. For example, when the extension switch 112 is fully attached (such that the extension switch 112 flushly abuts the housing of the networking device 100, such as shown in FIG. 1D), the shape and configuration of the housing 106 and position of the first network interface extension connector 107 cause an electrical connection to be made with the first network interface device connector 104.

The switch extension 112 also includes an extension power input connector 124 for receiving power, and an extension power output connector 114 (e.g., a barrel plug power connector) that is configured to be connected to (e.g., plugged into, attached to) the device power input connector 110 of the networking device 100 to provide electrical power to the networking device 100. The extension power output connector 114 and extension power input connector 124 (e.g., a power hole plug) are electrically coupled inside the housing 106 to enable power to flow from the extension power input connector 124 through the housing to the extension power output connector 114. As indicated by the dashed line, the power input connector 124 is also connected to the switching circuitry 128 to provide electrical power to the switching circuitry 128.

The switch extension 112 includes multiple second network interface extension connectors 126a-d attached proximal to (e.g., at or near) a second end 132 of the housing 106. In some examples, some or all of each of the second network interface extension connectors 126a-d reside within the housing 106, such as if the second network interface extension connectors 126 are sockets.

The second network interface extension connectors 126a-d are configured to be connected to wired cables, such as ethernet cables. In some examples, the second network interface extension connectors 126a-d are 8-pin connectors associated with a standardized interface, such as RJ45 connectors, that are configured to transceive signals at bandwidths of up to 1 Gbps, 2.5 Gps, 5 Gbps, or 10 Gbps each. In some examples, the second network interface extension connectors 126a-d are connected to the first network interface extension connector 105 via switching circuitry 128 within the housing to enable the switch extension 112 to switch between signals transceived via the second network interface extension connectors 126a-d. For example, the second network extension connectors 126a-d can be used to implement a multi-port switch 127 that enables the switching of signals received from (or sent to) the second network interface extension connectors 126a-d. In the example of FIG. 1C, the switch extension 112 adds four-port switching capability to the networking device 100. In other examples, there may be more than or fewer than four second network interface extension connectors 126a-d that implement a multi-port switch with a different number of ports (e.g., a two-port switch, an eight-port switch, etc.).

In some examples, the extension power output connector 114 of the switch extension 112 is located at a position on the first end 130 of the housing 106 such that it is aligned with the device power input connector 110 of the networking device 100 when the switch extension 112 is fully attached to the networking device using the tension clips 136. Similarly, the first network interface extension connector 107 of the switch extension 112 is located at a position on the first end 130 of the housing 106 such that it is aligned with the network interface device connector 104a of the networking device 100 when the switch extension 112 is attached to the networking device 100 using the tension clips 136.

In some examples, the tension clips 136 provide the only attachment point (e.g., clip) between the switch extension 112 and the networking device 100. When the switch extension 112 is physically attached to the networking device 100 with the tension clips 136 such that the first end 130 of the switch extension 112 flushly abuts the back side of the networking device 100 (e.g., the switch extension 112 cannot be physically moved closer to the networking device 100), the connectors of the switch extension 112 are inserted into (e.g., reside within) the opposite-gendered connectors of the networking device 100 at an insertion depth that results in an electrical (or optical) connection between the connectors of the switch extension 112 and the connectors of the networking device 100 (e.g., without a person having to manually plug each connector of the switch extension into the corresponding socket of the networking device 100). Thus, a user can push the switch extension 112 onto the networking device until it becomes flush with the end of the networking device 100 (e.g., until it flushly abuts the networking device 100), and the tension clips 136 will snap into the ribs to hold the switch extension 112 in place with the connectors inserted at the correct insertion depth to cause electrical or optical connections. In some examples, the connectors of the switch extension 112 can be removed by simply unsnapping the tension clips 136 and pulling the switch extension away from the networking device 100, without a person having to manually unplug each connector. For example, the first network interface extension connector 107 may lack a tab for clipping into the corresponding socket and may instead simply slide out without unclipping the connector 107. For example, the first network interface extension connector 107 may be a clipless male-gendered RJ45 connector; e.g., a male-gendered RJ45 connector that lacks an attachment tab for clipping the connector into a socket.

In some examples, the housing 106 of the switch extension 112 includes a cable passthrough 118 through which a cable, such as a fiber optic cable 120, can pass from the second end 132 of the switch extension 112 to the first end 130. The cable passthrough 118 includes a first opening 118a on the first end 130 of the housing, a second opening 118b on a second end of the housing 132, and a passageway 134 between the two openings. For example, a fiber cable 120 having a fiber connector 122 at a first end of the cable can pass through the passageway 134 such that the fiber connector 122 can be connected to the fiber interface device connector 108 of the networking device 100 when the switch extension 112 is attached (or is being attached) to the networking device 100. As shown in FIG. 1C, the fiber cable 120 and fiber connector extend beyond the first end 130 of the housing 106 to enable connection with the fiber interface device connector 108.

FIG. 1D depicts a top view of a networking system 138 that includes the switch extension 112 detachably connected to the networking device 100. As shown in the top view, a contour of the first side of the switch extension 112 is shaped (curved) to match a contour of the back side of the networking device 100 to enable the switch extension 112 to flushly abut the networking device 100. In FIG. 1D, four network interface cables 140a-d are plugged into the four corresponding second network interface extension connectors 126 of the switch extension 112, and a power cable 142 is plugged into the extension power input connector 124 of the switch extension 112. A fiber cable 120 is passed through the passthrough 118 of the switch extension 112.

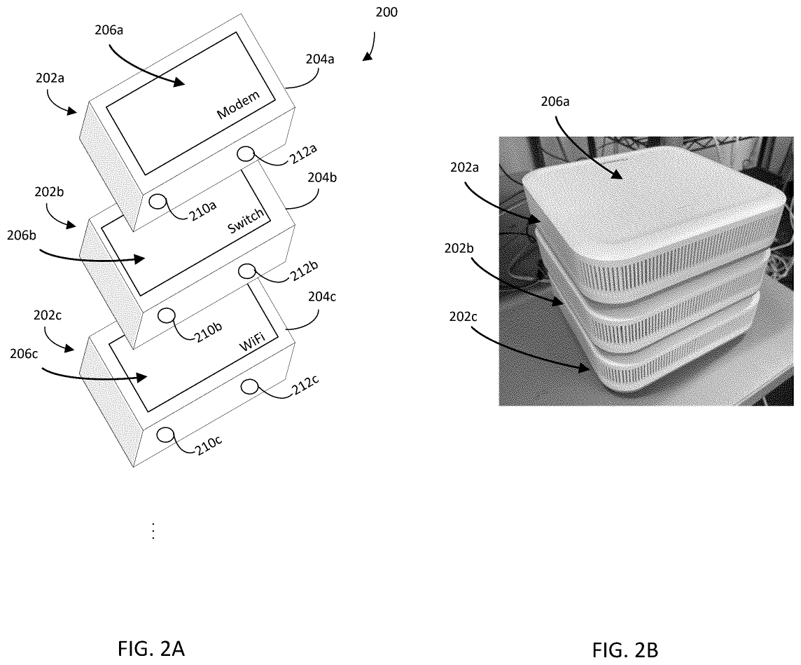

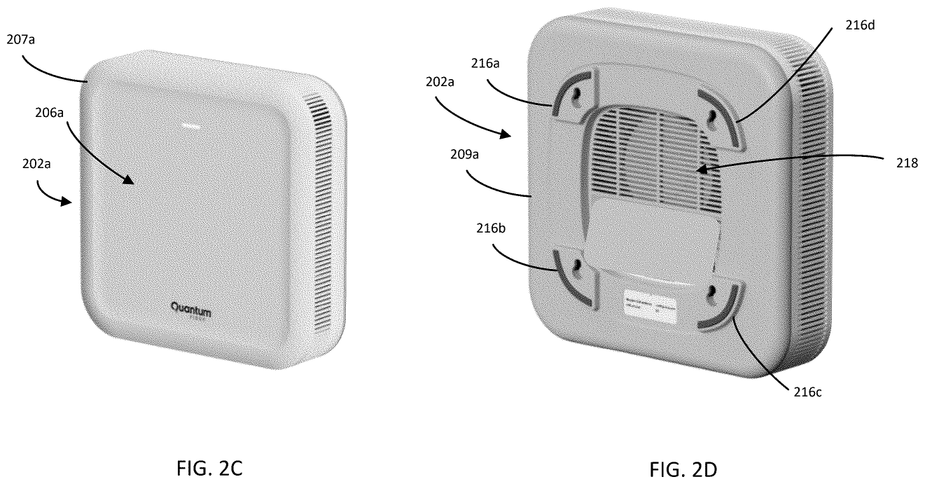

Additional modular communication systems are described with reference to FIGS. 2A-2D.

FIG. 2A depicts a modular communication system 200 that includes multiple modular components 202, including a modular modem component 202a, a modular switch component 202b, and a modular WiFi component 202c. In some examples, the modular modem component 202a includes modem circuitry configured to modulate digital signals into analog signals (and vice versa), such as by implementing a digital subscriber line (DSL) or PON modem. The modular WiFi component may enable wireless connection to a network using RF signals, such as by including WiFi circuitry configured to implement a WiFi standard (e.g., WiFi 6, WiFi 7, etc.). The modular switch component may include switching circuitry that enables switching between multiple inputs and/or outputs. Each modular component 202 includes a housing 204 having a first (same) form factor (e.g., size, shape, configuration, and dimensions), such as shown in FIG. 2B, and circuitry enclosed within the housing (e.g., modem circuitry, router circuitry, switching circuitry, and/or other types of circuitry).

Each modular component 202 further includes a power input connector 210 and a power output connector 212. The power input connectors 210 (e.g., power input connectors 210a-c) and power output connectors 212 (e.g., power output connectors 212a-c) may supply power and, in some cases, data to each of the modular components 202 such that power (and in some cases) data can be passed through each modular component 202 to the next modular component in the stack when the power output connectors 212 are connected to the power input connectors of the next modular component in the stack. For example, the power input connectors and power output connectors may include USB-C connectors that are capable of providing both power and data.

In some examples, additional modular components can include: a modular router component that routes signals to endpoint devices connected to the network, and/or a modular storage component for storing information, such as network-attached-storage.

In some examples, the housing 204 has a first side that includes an indented portion 206 (e.g., indented portions 206a-206c). For example, as shown in FIGS. 2A and 2B, modular component 202a has an indented portion 206a on a first side (e.g., a top side) of the modular component 202a.

FIGS. 2C-D depicts views of a modular component 202a of FIGS. 2A-B when it is standing on a side (e.g., rather than lying horizontally as shown in FIGS. 2A-2B).

FIG. 2C depicts a first (top) side 207a of the modular component 202a. As discussed with reference to FIGS. 2A-2B, the first side 207 has an indented portion 206a. FIG. 2D depicts a second (bottom) side 209a of modular component 202a opposite the first side. The second side 209a includes one or more protrusions 216a-216d that are configured to rest on the top side of another modular component (e.g., modular component 206b or 206c), within an indented portion of the top side of the other modular component.

When modular components having the housing illustrated in FIGS. 2A-2D are stacked as shown in FIG. 2B (e.g., when they are physically in contact), the protrusions 216 of a “top” modular component 202 fit into the indented portion 206a of a “bottom” modular component and are in contact with a top side of the bottom modular component to support the top modular component. For example, the outer perimeter defined by the protrusions 216 may fit entirely within the indented portion 206. In other examples, each protrusion 216 may fit within a corresponding one indented portion 206 (e.g., multiple indented portions 206 may be defined to receive corresponding protrusions 216. The protrusions 216 may provide spatial clearance between the bottom side of the modular component (which may include one or more vents 218) and the top side of another modular component when the modular components are stacked, thereby allowing heat to dissipate between the modular components.

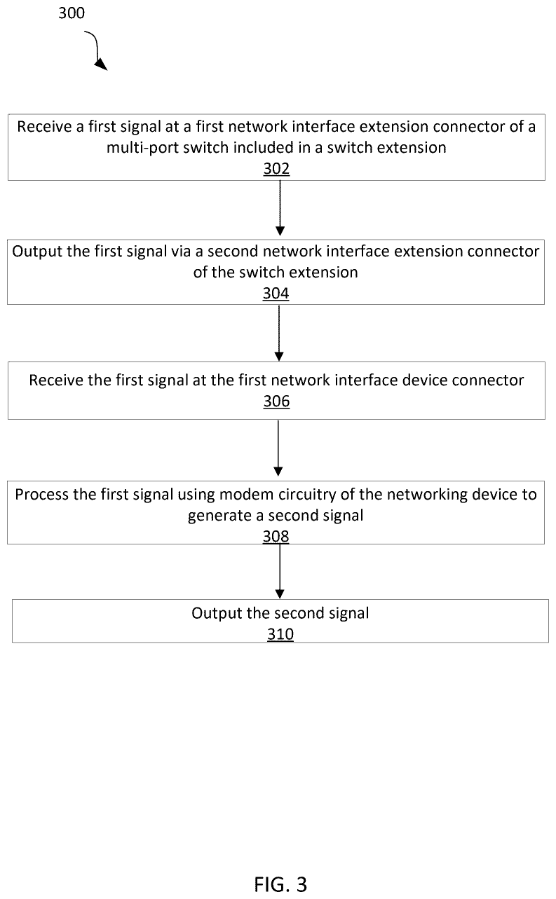

FIG. 3 depicts an example method 300 according to aspects of the present application. In examples, one or more of the operations of FIG. 3 can be performed by a network system that includes a networking device (such as networking device 100) and a switch extension (e.g., switch extension 112) coupled with the networking device.

At 302, a switch extension of the network system receives a first signal at a first network interface extension connector (e.g., network interface extension connector 126a of FIG. 1C) of a multi-port switch (e.g., multi-port switch 127) included in the switch extension. For example, the network system receives a signal, such as a packet, from a LAN or WAN.

At 304, the switch extension outputs the first signal via a second network interface extension connector (e.g., first network interface extension connector 105) of the switch extension. In some examples, the switch extension selects the first signal for outputting using switching circuitry (e.g., switching circuitry 128 of FIG. 1C) of the switch extension.

At 306, the networking device receives the first signal at the first network interface device connector (e.g., first network interface device connector 104a). In some examples, the first network interface device connector of the networking device is connected to the second network interface extension connector of the switch extension.

At 308, the networking device processes the first signal using circuitry of the networking device to generate a second signal. For example, the networking device processes the first signal using modem circuitry to format the first signal into a format appropriate for a LAN or WAN.

At 310, the networking device outputs the second signal. For example, the networking device outputs the second signal via the first network interface device connector (e.g., first network interface device connector 104a), via a second network interface device connector (e.g., second network interface device connector 104b), or via a fiber connector (e.g., fiber device connector 108).

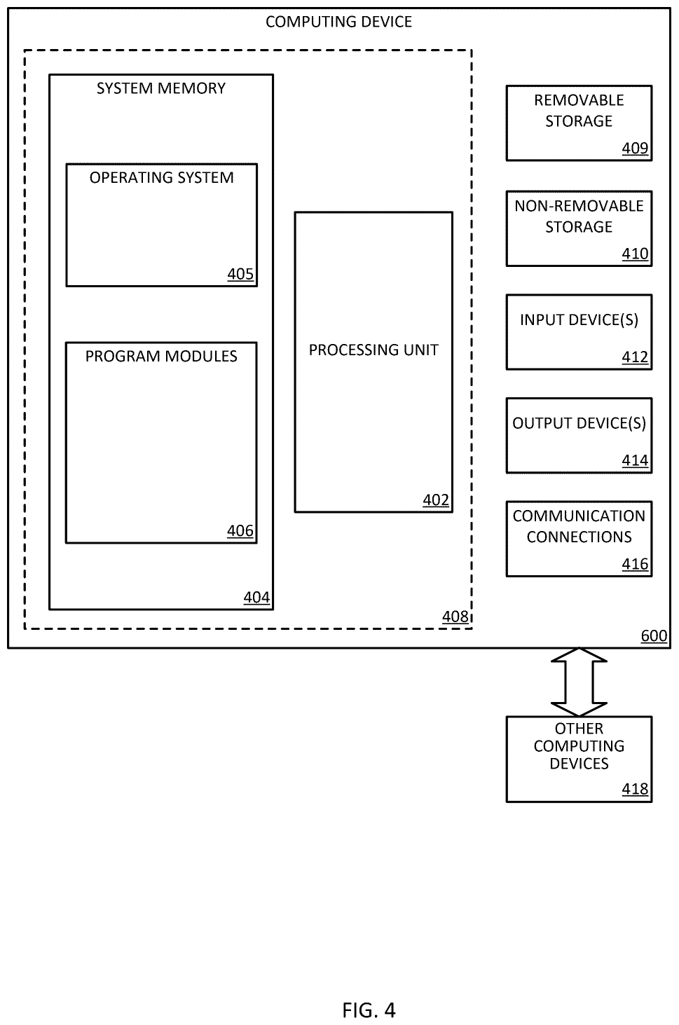

FIG. 4 is a block diagram illustrating physical components (i.e., hardware) of a computing device 400 with which examples of the present disclosure may be practiced. The computing device components described below may be suitable for a computing device(s) implementing (or included in) the networking device, switch extension, and/or modular component(s) of FIGS. 1A-2C. In a basic configuration, the computing device 400 may include at least one processing unit 402 and a system memory 404. The processing unit(s) (e.g., processors) may be referred to as a processing system. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 to implement one or more of the components or systems described above with respect to FIG. 1.

The operating system 405, for example, may be suitable for controlling the operation of the computing device 400. Furthermore, aspects of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the operations of the methods illustrated in FIG. 3. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418.

Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400 and/or coupled with computing device 400. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed:

1. A communication system comprising:
a switch extension configured to be detachably connected to a networking device, the switch extension comprising:
a housing configured to be detachably connected to an exterior of the networking device, the housing having a first end that flushly abuts the networking device when connected to the networking device and a second end that is opposite the first end;
a first network interface extension connector, attached to the housing proximal the first end of the housing and configured to be connected to a first network interface device connector of the networking device;
a plurality of second network interface extension connectors attached proximal the second end of the housing, electrically connected to the first network interface extension connector through switching circuitry of the switch extension;
an extension power output connector configured to connect to, and provide power to, a device power input connector of the networking device; and
an extension power input connector attached proximal to the second end of the housing and electrically connected to both the power output connector and the switching circuitry, wherein the extension power input connector is configured to provide power both to the networking device through the power output connector and to the switching circuitry.

2. The communication system of claim 1, further comprising:
a cable passthrough comprising a first opening on the first end of the housing, a second opening on a second end of the housing, and a passageway therebetween.

3. The communication system of claim 2, wherein the switch extension further comprises:
a fiber cable that passes through the cable passthrough, wherein a first end of the fiber cable extends beyond the second end of the housing and is configured to be connected with fiber interface device connector of the networking device.

4. The communication system of claim 3, wherein the fiber cable is a passive optical network (PON) cable.

5. The communication system of claim 1, wherein the first network interface extension connector is an 8-pin standardized interface connector.

6. The communication system of claim 5, wherein the 8-pin standardized interface connector is a clipless male-gendered RJ45 connector that supports a bandwidth of up to 10 gigabits/second (Gbps).

7. The communication system of claim 1, wherein the plurality of second network interface extension connectors comprises a plurality of 8-pin connectors each supporting a bandwidth of up to 1 Gbps, 2.5 Gbps, or 5 Gbps.

8. The communication system of claim 7, wherein the plurality of 8-pin connectors and the switching circuitry implement a four-port switch.

9. The communication of claim 1, further comprising the networking device.

10. A modular communication system comprising:
a modem modular component comprising:
a first housing having a first form factor, the first housing comprising a first power input connector and a first power output connector, and
modem circuitry enclosed by the first housing and coupled with the first power input connector; and
a WiFi modular component comprising:
a second housing having the first form factor, the second housing comprising a second power input connector and a second power output connector, and
WiFi circuitry enclosed by the second housing and coupled with the second power input connector,
wherein the WiFi module is configured to be coupled with the modem module by connecting the first power output connector with the second power input connector.

11. The modular communication system of claim 10, further comprising:
a router modular component comprising:
a third housing having the first form factor, the third housing comprising a third power input connector and a third power output connector, and
router circuitry enclosed by the third housing and coupled with the third power input connector, wherein the router module is configured to be coupled, via the third power input connector, with one of: the first power output connector of the modem module or the second power output connector of the WiFi module.

12. The modular communication system of claim 10, further comprising:
a storage modular component comprising:
a fourth housing having the first form factor, the fourth housing comprising a fourth power input connector and a fourth power output connector, and
storage circuitry enclosed by the fourth housing and coupled with the fourth power input connector, wherein the storage module is configured to be coupled, via the fourth power input connector, with one of: the first power output connector of the modem module or the second power output connector of the WiFi module.

13. The modular communication system of claim 10, wherein the first form factor comprises a first side that includes an indented portion and a second side opposite the first side that includes one or more protrusions.

14. The modular communication system of claim 10, wherein the first power input connector of the modem module is configured to receive first power and first data and the first power output connector is configured to supply second power and second data to the second power input connector of the WiFi module.

15. The modular communication system of claim 10, wherein the WiFi circuitry supports a WiFi standard.

16. The modular communication system of claim 10, wherein the modem circuitry supports a digital subscriber line (DSL) standard, a PON standard, or both.

17. A method performed at a networking system comprising a switch extension detachably connected to a networking device, the method comprising:
receiving a first signal at a first network interface extension connector of a multi-port switch included in the switch extension;
outputting the first signal via a second network interface extension connector of the switch extension;
receiving the first signal at a first network interface device connector; and
processing the first signal using modem circuitry of the networking device to generate a second signal; and
outputting the second signal.

18. The method of claim 17, further comprising:
routing the second signal to an endpoint device using a router of the networking device.

19. The method of claim 17, further comprising:
receiving a third signal via a fiber device connector of the networking device;
processing the third signal using circuitry of the networking device to generate a fourth signal;
outputting the fourth signal via the first network interface device connector;
receiving the fourth signal at the second network interface extension connector; and
outputting the fourth signal via a third network interface extension connector of the multi-port switch.

20. The method of claim 19, wherein the first signal is received at 10 Gbps and the fourth signal is outputted at 1 Gbps.
